(19) United States
(12) Patent Application Publication
(10) Pub. No.: US 2012/0055360 A1
(43) Pub. Date: Mar. 8, 2012

(54) RELIEF PRINTING PLATE, PLATE-MAKING METHOD FOR THE RELIEF PRINTING PLATE AND PLATE-MAKING APPARATUS FOR THE RELIEF PRINTING PLATE

(75) Inventors: Mitsuru Mushano, Kanagawa (JP); Masashi Norimatsu, Kanagawa (JP); Shuichi Otsuka, Kanagawa (JP)

(73) Assignee: FUJIFILM Corporation, Minato-ku, Tokyo (JP)

(21) Appl. No.: 13/138,793

(22) PCT Filed: Mar. 30, 2010
(86) PCT No.: PCT/JP2010/056135

§ 371 Date: Nov. 7, 2011

(30) Foreign Application Priority Data
Mar. 31, 2009 (JP) 2009087843

(51) Int. Cl. B41N 1/00; H04N 1/405

(52) U.S. Cl. 101/395; 358/3.06

(57) ABSTRACT

In a relief printing plate according to an aspect of the present invention, the relief can be formed to have resistance to pressure applied to the apex thereof thanks to the depth (d) and the ridge tilt angle (x). In particular, the resistance to pressure against a relief serving as a highlight halftone dot can be improved to prevent the relief from falling over by the pressure applied to the apex of the relief. Thereby, the relief serving as a highlight halftone dot can be made not to be dipped in a cell of the ink roller (e.g., anilox roller).

### TECHNICAL FIELD

The present invention relates to a relief printing plate, a plate-making method for the relief printing plate and a plate-making apparatus for the relief printing plate, and particularly to a relief printing plate made by performing laser engraving on a flexographic plate material, a plate-making method for the relief printing plate and a plate-making apparatus for the relief printing plate.

### BACKGROUND ART

As illustrated in FIG. 14, a flexographic printer is mainly configured to include a flexographic printing plate (relief printing plate having reliefs serving as dots formed on a plastic sheet) 1, a plate cylinder 4 on which the flexographic printing plate 1 is mounted with a cushion tape 2 such as a double-sided tape therebetween, an anilox roller 8 to which ink is supplied from a doctor chamber 6, and an impression cylinder 9.

The top portion of each relief of the flexographic printing plate 1 receives ink from the anilox roller 8, and the ink is transferred to a substrate 3 which is pinched and conveyed between the plate cylinder 4 on which the flexographic printing plate 1 is mounted and the impression cylinder 9.

FIG. 15 illustrates an example of sizes of a surface of the anilox roller 8 and highlight halftone dots (1% halftone dot and 5% halftone dot) of the flexographic printing plate 1. In the example illustrated in FIG. 15, the size of a grid-like groove (cell) 8A holding ink of the anilox roller 8 is larger than the 1% halftone dot.

Conventionally, there is a problem in that when ink is transferred to the flexographic printing plate 1 from the anilox roller 8, a relief serving as a highlight halftone dot located on a grid of the anilox roller 8 folds over due to a pressure against the anilox roller 8; as a result, the relief serving as a highlight halftone dot located in the cell 8A of the anilox roller 8 is dipped in the cell 8A; ink is transferred to not only the top surface of the relief but also other places (too much inked); and thereby reproduction of highlights is unreliable.

The following methods have been available for solving the above problem.

(1) A method of increasing the size of the highlight halftone dot more than that of the cell 8A of the anilox roller 8 and reducing the number of highlight halftone dots by that much.

(2) A method by which as illustrated in FIG. 15, mixed sizes of highlight halftone dots such as a big size dot (5% halftone dot) and a small size dot (1% halftone dot) are prepared so that the big size dots can absorb the pressure of the anilox roller 8 to prevent the small size dots from folding over.

However, the above methods have a problem in that a highlighted portion has a noticeable grainy appearance and thus is not suitable for printing requiring high image quality. Moreover, the above methods have a problem in that if the size of the cell 8A of the anilox roller 8 is reduced more than that of the 1% halftone dot, the volume of ink held in the cell 8A becomes too small.

Alternatively, there has been proposed a flexographic printing plate capable of reliably printing highlight halftone dots by inserting a plurality of small non-printing dots around an isolated highlight halftone dot (Patent Literature 1).

Alternatively, Patent Literature 2 discloses a method of making a printing plate for flexographic printing characterized by performing laser engraving by combining different laser engraving conditions by demarcating at least one or more halftone dot area ratio in the range of 5% or more and 40% or less. It should be noted that the laser engraving conditions are to change halftone dot height and halftone dot angle by considering dot gain. More specifically, the height of the dot portion is changed from the height of the solid portion so that the solid portion absorbs the pressure in printing and the thickness of the dot portion is reduced; and the halftone dot angle is changed in the range where the dot area is 70% or less and the halftone dot angle is 0° or more and 60° or less.

### CITATION LIST

### Patent Literature

[Patent Literature 1] U.S. Pat. No. 7,126,724
[Patent Literature 2] Japanese Patent Application Laid-Open No. 2007-185917

### SUMMARY OF INVENTION

### Technical Problem

However, Patent Literature 1 gives a description that a highlight halftone dot can be reliably printed by inserting a plurality of non-printing small dots around the isolated highlight halftone dot, but does not explicitly disclose the reason for this.

In addition, Patent Literature 2 gives a description that by demarcating one or more halftone dot area ratio, the halftone dot height is changed so that the height of the dot portion is changed from the height of the solid portion, but does not have a description that the height of the dot portion is changed so as to increase resistance to pressure applied to the highlight halftone dot. Moreover, Patent Literature 2 gives a description that a dot shape excellent in printing quality, particularly in dot gain quality, can be acquired by changing the halftone dot angle (angle forming a dot top) in the range where the dot area is 70% or less and the halftone dot angle is 0° or more and 60° or less, but does not disclose the reason for acquiring the excellent dot shape.

In view of this, the present invention has been made, and an object of the present invention is to provide a relief printing plate, a plate-making method for the relief printing plate and a plate-making apparatus for the relief printing plate capable of reproducing an excellent highlight by preventing a relief serving as a highlight halftone dot from being dipped in a cell of an anilox roller even if the size of the highlight halftone dot is smaller than that of the cell of the anilox roller.

### Solution to Problem

In order to achieve the aforementioned object, a first aspect of the invention provides a relief printing plate comprising: a plate material; and frustoconical relief which is formed on a surface of the plate material and serves as a dot, characterized in that the relief is formed in such a manner that each relief is different in depth and ridge tilt angle depending on a size of an apex of the relief to which ink is transferred by an ink roller.

The frustoconical relief can be formed to have resistance to pressure applied to the apex thereof thanks to the depth and the ridge tilt angle. In particular, the resistance to pressure against a relief serving as a highlight halftone dot can be improved to prevent the relief from falling over by the pressure applied to the apex of the relief. Thereby, the relief serving as the highlight halftone dot can be made not to be dipped in a cell of the ink roller (e.g., anilox roller).

As disclosed in a second aspect of the invention, the relief printing plate according to the first aspect is characterized in that the relief is formed in such a manner that the smaller the size of the apex is, the smaller the depth of the relief becomes as well as the smaller the ridge tilt angle of the relief becomes.

That is, a relief with a large apex (large halftone dot area ratio) is originally formed to be thick, and thus has high resistance to pressure applied to the apex of the relief. In contrast, a relief of a highlight halftone dot with a small apex has low resistance to pressure applied to the apex of the relief. Therefore, the resistance to pressure applied to the apex of the relief is made to be improved by reducing the depth of the relief and reducing the tilt angle of the ridge line of the frustoconical relief (thickening the root portion).

As disclosed in a third aspect of the present invention, the relief printing plate according to the first or second aspect is characterized in that the relief is formed in such a manner that the depth and the ridge tilt angle of the relief is changed only if the size of the apex of the relief is a predetermined size or smaller. As the predetermined size of the apex of the relief is, for example, a size corresponding to a highlight halftone dot.

As disclosed in a fourth aspect of the invention, the relief printing plate according to any one of the first to third aspects is characterized in that the relief has an elliptical frustoconical shape having a minor axis in a same direction as a printing direction.

If the relief loses flexibility as a result of increasing resistance to pressure applied to the apex of the relief, slight slipping or sliding occurs in the period (about 10 mm) while the relief is being fed in contact with the substrate, causing dot gain. According to the invention in accordance with the fourth aspect, the relief is formed to have an elliptical frustoconical shape having a minor axis in a same direction as a printing direction so that the relief has resistance to pressure as a whole and can be flexible in the printing direction. Therefore, a halftone dot without dot gain can be printed.

As disclosed in a fifth aspect of the invention, the relief printing plate according to any one of the first to fourth aspects is characterized in that the relief is formed in such a manner that a cap having a constant cross-section and a predetermined height is formed on the apex of the relief. Thereby, the size of a halftone dot can be made constant regardless of the pressure in printing.

A sixth aspect of the invention provides a plate-making method for making the relief printing plate according to any one of the first to fifth aspects, the method comprising: a step of acquiring screened binary image data and multi-value image data representing a tone of each halftone dot; a step of calculating depth data, which is depth data corresponding to a shape of a relief of each halftone dot, for each exposure scanning position on a plate material by a laser engraver based on the binary image data and the multi-value image data; and a step of performing laser engraving on the plate material by the laser engraver based on the depth data of each of the exposure scanning position.

The relief printing plate according to any one of the first to fifth aspects is made in such a manner that the planar shape of a relief of each halftone dot can be obtained from screened binary image data; the depth data representing a three-dimensional shape (depth) of a relief of each halftone dot can be obtained from multi-value image data representing a tone of each halftone dot; and then, the laser engraver performs laser engraving on the plate material based on the depth data of each of the exposure scanning position.

As disclosed in a seventh aspect of the invention, the plate-making method for the relief printing plate according to the sixth aspect is characterized in that the step of calculating depth data for each exposure scanning position includes: a step of initializing depth data stored in a depth data memory area corresponding to the exposure scanning position based on the binary image data and the multi-value image data, the step of initializing to 0s the depth data of a memory area corresponding to an ON pixel within a halftone dot matrix representing a tone of a halftone dot based on the binary image data as well as initializing depth data of a memory area corresponding to an OFF pixel within the halftone dot matrix to depth data corresponding to multi-value image data of a halftone dot represented by the halftone dot matrix; a step of acquiring conical basic shape data corresponding to a ridge tilt angle of a relief based on multi-value image data of each halftone dot; a step of moving an apex of the basic shape data once along an outer circumference of a circle of ON pixels constituting a halftone dot; and a step of updating the depth data stored in the memory area by the initialized depth data and the basic shape data, whichever is smaller, at each pixel constituting the outer circumference during the moving.

That is, the binary image data determines the ON pixel (planar shape of the apex of a relief of each halftone dot) within a halftone dot matrix of each halftone dot, and thus the depth data of a memory area corresponding to the ON pixel is initialized to 0s. Meanwhile, multi-value image data determines the depth of the frustoconical relief, and thus the depth data of a memory area corresponding to an OFF pixel within the halftone dot matrix is initialized to the depth data corresponding to multi-value image data.

Then, conical basic shape data corresponding to a ridge tilt angle of a relief is acquired based on multi-value image data of each halftone dot. The depth data stored in the memory area is updated by the depth data initialized when an apex of the basic shape data is moved once along an outer circumference of a circle of ON pixels constituting a halftone dot and the basic shape data, whichever is smaller. Thereby, the depth data for laser engraving for leaving a frustoconical relief having a tilt angle of the ridgeline and the apex having a halftone dot area ratio can be calculated.

As disclosed in an eighth aspect of the invention, the plate-making method, for the relief printing plate according to the seventh aspect is characterized by further comprising a first table or a first relational expression representing a relationship between a tone of multi-value image data and depth data of a relief of the halftone dot, wherein the initialization step is to acquire depth data corresponding to the multi-value image data from the first table or the first relational expression based on multi-value image data of a halftone dot within a halftone dot matrix and to perform initialization using the acquired depth data.

As disclosed in a ninth aspect of the invention, the plate-making method for the relief printing plate according to the seventh or eighth aspect is characterized by further comprising a second table or a second relational expression representing a relationship between a tone of multi-value image data and a tilt angle of a ridge of a relief of the halftone dot, wherein the conical basic shape data includes parameters: a tilt angle of a ridge of a cone, a cap height with a predetermined height above the apex of the cone, and a maximum depth which is a sum of the cone height and the cap height, and wherein the step of acquiring the basic shape data is to acquire a ridge tilt angle of a relief corresponding to the multi-value image data from the second table or the second relational expression based on the multi-value image data of each halftone do and to calculate the basic shape data based on the acquired tilt angle, the cap height, and the maximum depth.

A tenth aspect of the invention provides a plate-making apparatus for making the relief printing plate according to any one of the first to fifth aspects, characterized by comprising: a data acquisition device which acquires screened binary image data and multi-value image data representing a tone of each halftone dot; a three-dimensional conversion device which calculates depth data, which is depth data corresponding to a shape of a relief of each halftone dot, for each exposure scanning position on a plate material by a laser engraver based on the acquired binary image data and the multi-value image data; and a laser engraver which performs laser engraving on the plate material based on the depth data for each exposure scanning position calculated by the three-dimensional conversion device.

As in an eleventh aspect of the invention, when the input data is page data, the data acquisition device acquires multi-value image data by converting the page data to multi-value image data for each page by a RIP (Raster Image Processor) as well as can acquire binary image data by screening the multi-value image data under a preliminarily specified conditions such as the halftone dot, the angle, the number of lines, and the like. On the other hand, when the input data is screened binary image data, the data acquisition device acquires multi-value image data by de-screening the binary image data. The depth data for each exposure scanning position on a plate material by a laser engraver is calculated based on the acquired screened binary image data and the multi-value image data. Then, the laser engraver performs laser engraving on the plate material based on the depth data. Thus, the relief printing plate according to any one of the first to fifth aspects is made in the aforementioned manner.

### Advantageous Effects of Invention

According to the present invention, the frustoconical relief which is to be formed on a surface of the plate material and serve as a halftone dot is formed by changing the depth and the ridge tilt angle according to the size (size of the halftone dot) of the apex of each relief. Thus, the relief can be formed to have resistance to pressure applied to the apex of the relief regardless of the size of the halftone dot. In particular, the resistance to pressure against a relief serving as a highlight halftone dot can be improved to prevent the relief from falling over by the pressure applied to the apex of the relief. Thereby, the relief serving as a highlight halftone dot can be made not to be dipped in a cell of the ink roller (e.g., anilox roller), and an excellent highlight can be reproduced.

### BRIEF DESCRIPTION OF DRAWINGS

FIG. 1 is a schematic block diagram of a plate-making apparatus for a relief printing plate in accordance with a first embodiment of the present invention;

FIG. 2 is a plan view illustrating an outline of a laser engraver;

FIG. 3 is a schematic block diagram of a plate-making apparatus for a relief printing plate in accordance with a second embodiment of the present invention;

FIG. 4 is a flowchart illustrating a three-dimensional conversion process of generating three-dimensional data containing depth data for control the laser engraver;

FIG. 5 explains a parameter for determining conical basic shape data;

FIGS. 6A and 6B illustrate how depth data memory area values are updated;

FIG. 7 illustrates an example of a tone-depth conversion table;

FIG. 8 illustrates an example of a tone-tilt angle conversion table;

FIG. 9 illustrates an example of a 16×16 matrix representing a halftone dot and dots (ON pixels) constituting the halftone dot;

FIG. 10 illustrates an example of a longitudinal section of the flexographic printing plate (relief printing plate) in accordance with the present invention;

FIG. 11 is an enlarged view of the essential parts of a flexographic printer;

FIG. 12 illustrates another example of the tone-tilt angle conversion table;

FIGS. 13A to 13C illustrate an elliptical frustoconical relief formed on a surface of the flexographic printing plate; FIG. 13A is a plan view illustrating the elliptical frustoconical relief; and FIGS. 13B and 13C each are a sectional view as viewed from the B-B line and the C-C line of FIG. 13A respectively.

FIG. 14 illustrates a configuration example of the essential parts of the flexographic printer; and

FIG. 15 illustrates an example of sizes of a surface of an anilox roller and highlight halftone dots of the flexographic printing plate.

### DESCRIPTION OF EMBODIMENTS

Hereinafter, embodiments of a relief printing plate, a plate-making method for the relief printing plate and a plate-making apparatus for the relief printing plate in accordance with the present invention will be described based on the accompanying drawings.

### First Embodiment of Plate-Making Apparatus for Relief Printing Plate

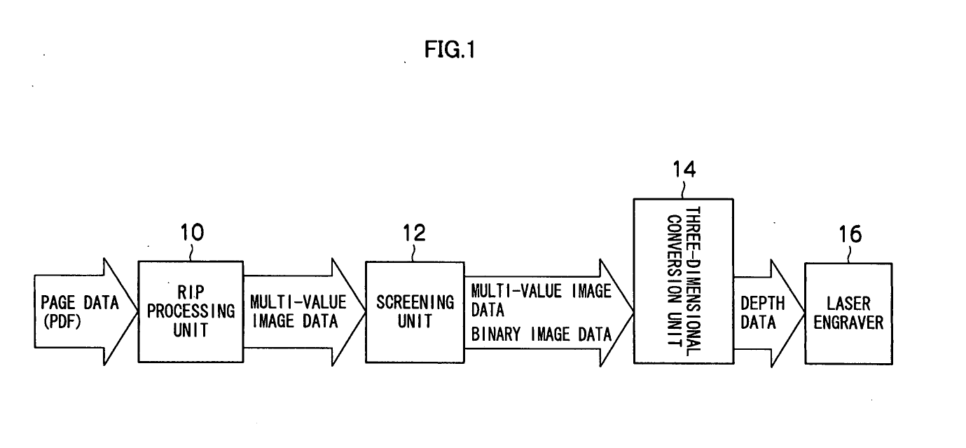

FIG. 1 is a schematic block diagram of a plate-making apparatus for a relief printing plate in accordance with a first embodiment of the present invention.

As illustrated in FIG. 1, this plate-making apparatus mainly includes a RIP processing unit 10, a screening unit 12, a three-dimensional conversion unit 14, and a laser engraver 16.

The RIP processing unit 10 converts page data (mostly PDF (Portable Document Format) files) to multi-value image data for each page and outputs it to the screening unit 12. Note that if the page data contains a color image, multi-value image data for four colors (Y, M, C, and K) are generated.

The screening unit 12 performs screening on the input multi-value image data under preliminarily specified conditions such as the halftone dot, the angle, the number of lines, and the like to generate binary image data and passes both the multi-value image data and the binary image data to the three-dimensional conversion unit 14. For example, assuming that the number of screen lines is 175 lines per inch and the number of tones represented by one dot is 256 (=16×16) tones, the screening unit 12 generates a binary bit map data with a resolution of 2800 (=175×16) dpi. It should be noted that the screening unit 12 may perform resolution conversion on the multi-value image data to reduce the amount of data before passing it to the three-dimensional conversion unit 14.

The three-dimensional conversion unit 14 uses the input binary image data and the multi-value image data to calculate depth data, which is depth data corresponding to the relief shape of each halftone dot, for each exposure scanning position on the flexographic plate material (elastic material made of synthetic resin, rubber, or the like) by the laser engraver 16. Note that the detail about the three-dimensional process of calculating depth data by the three-dimensional conversion unit 14 will be described later.

On the basis of the three-dimensional data containing depth data inputted from the three-dimensional conversion unit 14, the laser engraver 16 performs laser engraving on the flexographic plate material to form a frustoconical relief (convex portion) serving as a dot on a surface of the flexographic plate material.

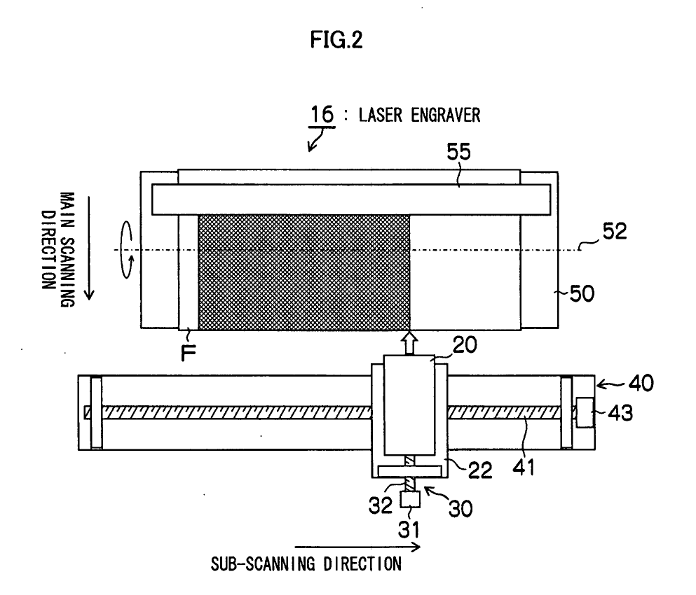

FIG. 2 is a plan view illustrating an outline of the laser engraver 16.

An exposure head 20 of the laser engraver 16 includes a focus position change mechanism 30 and an intermittent feeding mechanism 40 in a sub-scanning direction.

The focus position change mechanism 30 includes a motor 31 and a ball screw 32 which move the exposure head 20 back and forth with respect to a surface of the drum 50 on which a flexographic plate material F is mounted, and can control the motor 31 to move the focus position. The intermittent feeding mechanism 40, which moves a stage 22, on which the exposure head 20 is mounted, in a sub-scanning direction, includes a ball screw 41 and a sub-scanning motor 43 which rotates the ball screw 41, and can control the sub-scanning motor 43 to intermittently feed the exposure head 20 in a direction of an axis line 52 of a drum 50.

Moreover, in FIG. 2, reference numeral 55 designates a chuck member which chucks the flexographic plate material F on the drum 50. The chuck member 55 is located in a region where exposure by the exposure head 20 is not performed. While the drum 50 is being rotated, the exposure head 20 irradiates the plate material F on the rotating drum 50 with laser beam to perform laser engraving to form a relief on the surface of the flexographic plate material F. Then, when the drum 50 is rotated and the chuck member 55 passes in front of the exposure head 20, intermittent feeding is performed in the sub-scanning direction to perform laser engraving on a next line.

In this manner, for each rotation of the drum 52, feeding of the flexographic plate material F in the main scanning direction and intermittent feeding of the exposure head 20 in the sub-scanning direction are repeated to control the exposure scanning position as well as to control the intensity of the laser beam and on/off thereof based on depth data for each exposure scanning position, so as to perform laser engraving to form a desired shape of relief on the entire surface of the flexographic plate material F.

### Second Embodiment of Plate-Making Apparatus for Relief Printing Plate

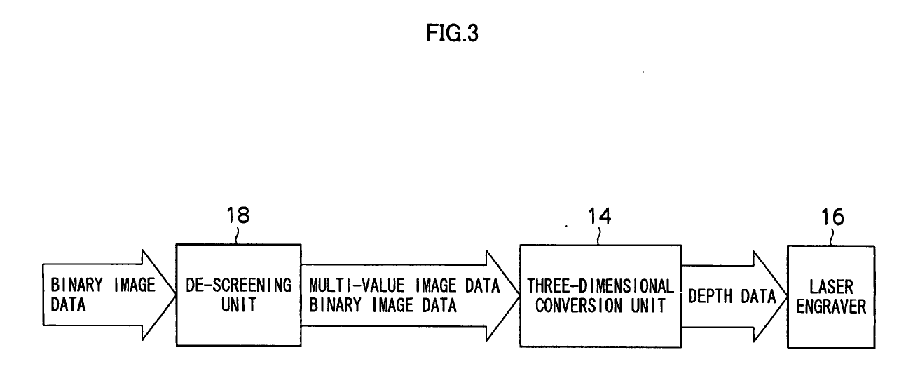

FIG. 3 is a schematic block diagram of a plate-making apparatus for a relief printing plate in accordance with a second embodiment of the present invention. It should be noted that in FIG. 3, the same reference numerals or characters are assigned to the components common to the first embodiment illustrated FIG. 1, and the detailed description is omitted.

The plate-making apparatus for the relief printing plate in accordance with the second embodiment illustrated in FIG. 3, which inputs screened binary image data, differs from the first embodiment in that a de-screening unit 18 is provided instead of the RIP processing unit 10 and the screening unit 12.

When the screened binary image data is received, the de-screening unit 18 performs de-screening to acquire multi-value image data.

For example, when 256-tone multi-value image data is acquired from the inputted binary image data, two values 0 and 255 are used as the binary image data. Then, a blurring filter is used for filtering to erase a halftone dot structure (cycle and angle). As the blurring filter used for de-screening, a Gaussian filter is generally used.

The de-screening unit 18 passes both the inputted binary image data and the multi-value image data generated by de-screening to the three-dimensional conversion unit 14.

Note that as a preferred example, there is a de-screening method disclosed in Japanese Patent Application Laid-Open No. 2005-217761. Alternatively, a Gaussian filter may also be used for a complicated case where page data contains a plurality of lines and angles, and for an FM screen, and the like. In this case, in order to sufficiently erase the halftone dot structure, it is preferable to use a Gaussian filter with a radius of 0.8 to 1.5 times the number of lines.

Alternatively, as disclosed in Japanese Patent Application Laid-Open No. 2007-194780, it is more preferable to have a function to extract only a halftone dot portion from within a page to perform de-screening on that portion.

### First Embodiment of Three-Dimensional Conversion Method

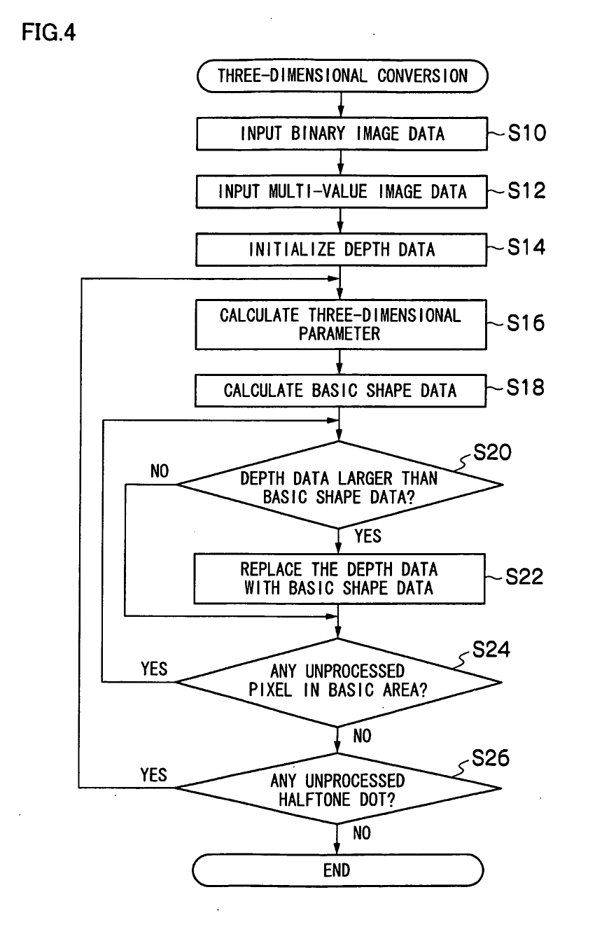

FIG. 4 is a flowchart illustrating a three-dimensional conversion process of generating three-dimensional data containing depth data for control the laser engraver 16 based on binary image data and multi-value image data.

In FIG. 4, the three-dimensional conversion unit 14 (FIG. 1) inputs the screened binary image data and the multi-value image data representing a tone of each halftone dot (Steps S10 and S12).

Then, the three-dimensional conversion unit 14 uses the inputted binary image data and the multi-value image data to initialize the depth data (Step S14).

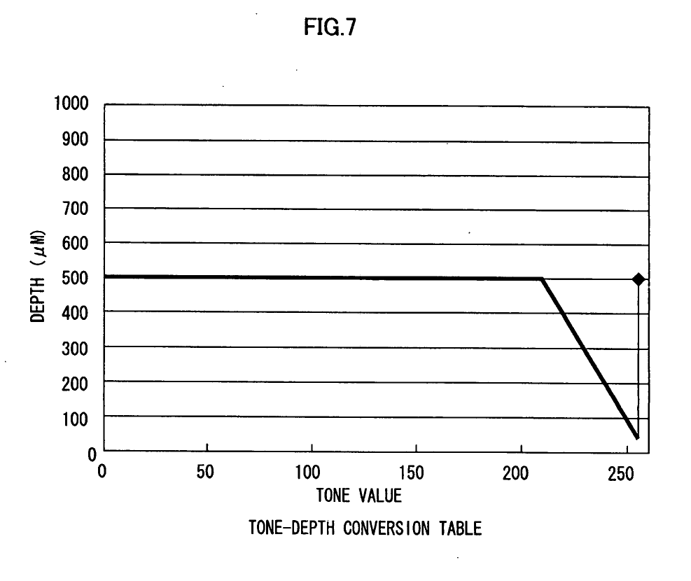

In this initialization, first, a depth data memory area, which has the same width/height as that of the screened binary image data, for the necessary number of bits (here 16 bits) capable of representing desired depth data is reserved. Then, the value of multi-value image data corresponding to each pixel of this depth data memory area is used as an input value to read the depth data corresponding to the input value from the tone-depth conversion table illustrated in FIG. 7 and set the read depth data to the depth data of the pixel in the depth data memory area.

The tone-depth conversion table of FIG. 7 illustrates a relationship between the 256 tone values from 0 to 255 and the depth of a relief (depth data) corresponding to each tone value. In the example of FIG. 7, the depth data corresponding to a tone value of about 210 or less is constant 500 μm, while in a highlight tone exceeding a tone value of about 210, the more the tone value, the smaller the depth data is.

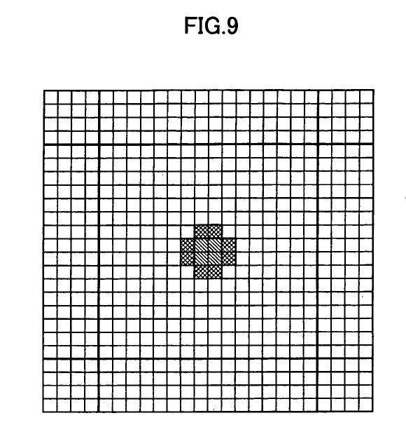

For example, when a halftone dot is represented by dots (ON pixels) in a 16×16 matrix (halftone dot matrix) enclosed by a heavy line as illustrated in FIG. 9, in the first step of initializing the depth data memory area, the depth data read from the tone-depth conversion table based on the tone of each halftone dot (multi-value image data) is stored in the address of a depth data memory area corresponding to each cell of the halftone dot matrix. Note that the halftone dot matrix can represent the 256 halftone dots by the number of ON pixels (halftone dot area ratio) in the 256 (=16×16) pixels.

Then, a value of 0 is set to the depth data corresponding to all ON pixels (upper surface portion of the convex, namely, shaded 12 pixels in the center portion of the halftone dot matrix in the example of FIG. 9) of the binary image data.

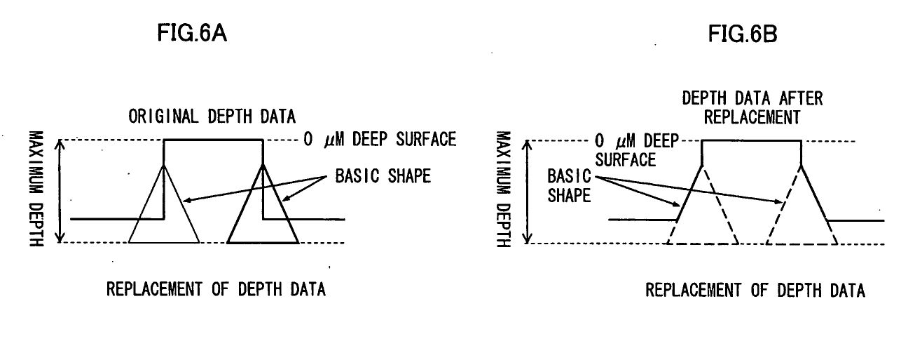

As a result, as illustrated in FIG. 6A, the depth data corresponding to the ON pixels in the halftone dot matrix is initialized to 0s, and the depth data corresponding to the OFF pixels is initialized to the depth data read from the tone-depth conversion table based on the tone of each halftone dot.

Now, by referring back to FIG. 4, when the depth data initialization is completed, the following three-dimensional parameters are calculated based on the tone of each halftone dot (multi-value image data) (Step S16). The following process is applied to only the ON pixels in the binary image data.

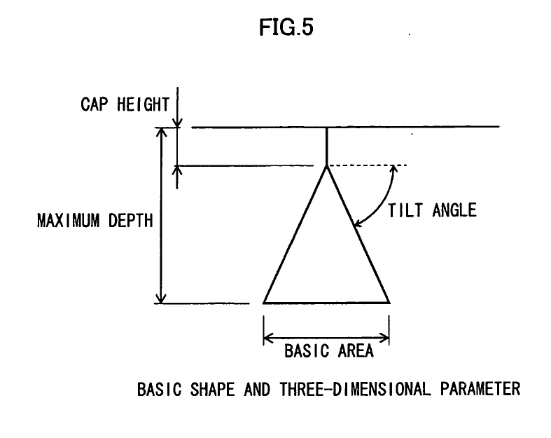

The three-dimensional parameters determine conical basic shape data illustrated in FIG. 5 and include four parameters: a tilt angle of a ridge line (bus line) of a cone, a cap height with a predetermined height above the apex of the cone, a maximum depth which is a sum of the cone height and the cap height, and a basic area.

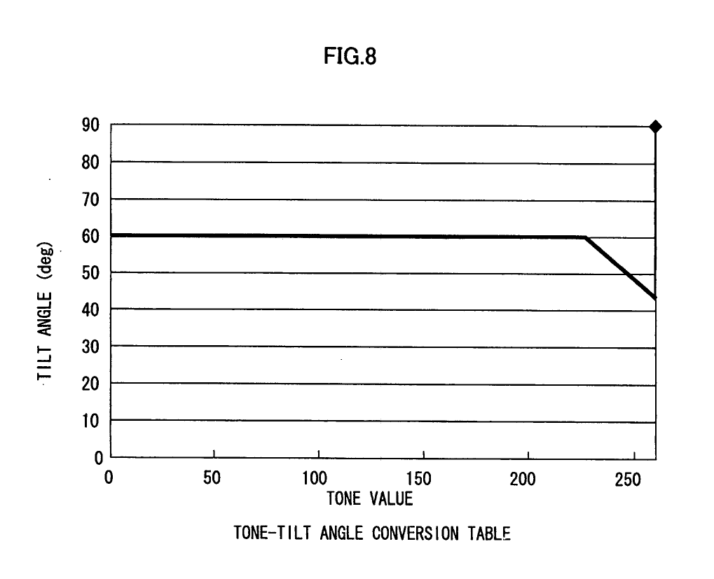

Here, the maximum depth and the cap height are assumed to be preliminarily determined fixed data. In addition, assuming that a value of the multi-value image data corresponding to all the ON pixels in the binary image data is used as the input value, the tilt angle is acquired by reading the tilt angle corresponding to the input value from the tone-tilt angle conversion table illustrated in FIG. 8. These three parameters are used to calculate the basic area. This is for the purpose of increasing efficiency by reducing subsequent waste processing.

The tone-tilt angle conversion table of FIG. 8 illustrates a relationship between the 256 tone values from 0 to 255 and the tilt angle of a relief corresponding to each tone value. In the example of FIG. 8, the tilt angle corresponding to a tone value of about 220 or less is constant 60°, while in a highlight tone exceeding a tone value of about 220, the more tone value, the smaller the tilt angle.

Next, conical basic shape data is calculated from the tilt angle read from the tone-tilt angle conversion table of FIG. 8 based on the multi-value image data (tone) of a halftone dot and the preliminarily determined fixed data of the maximum depth and the cap height (Step S18).

Then, three-dimensional data of the basic shape data in a state where the top of the cap of the above calculated basic shape data is positioned on the ON pixels in the binary image data is acquired. Then, this three-dimensional data (basic shape data) is compared with the depth data stored in the depth data memory area. If the depth data is larger than the basic shape data, the depth data is replaced with the basic shape data (Steps S20 and S22).

Then, a determination is made as to whether there is any unprocessed ON pixel of the ON pixels in the binary image data (Step S24). If an unprocessed ON pixel is found, the apex of the cap of the basic shape data is moved to the pixel. The above Steps S20 and S22 are repeated until no unprocessed ON pixel is found.

FIG. 6B illustrates depth data after the basic shape data (depth data) acquired by moving basic shape data to the position of the ON pixel in series is compared with the depth data stored in the depth data memory area and the depth data is replaced with whichever is shallow data.

Thereby, three-dimensional data containing depth data for engraving a conical relief having a cap with a predetermined cap height can be acquired.

Note that when one halftone dot consists of five or more continuous ON pixels, the basic shape data may not move on the ON pixels inside the halftone dot, but may move once along the outer circumference of a circle of the halftone dot (in the ON pixels).

For example, as illustrated in FIG. 9, if the one halftone dot consists of 12 ON pixels, the apex of the basic shape data may sequentially move onto each of the eight ON pixels located on the outer circumference thereof.

Now, by referring back to FIG. 4, when the three-dimensional data conversion with respect to one halftone dot is completed, a determination is made as to whether there is any unprocessed halftone dot (Step S26). If an unprocessed halftone dot is found, the process returns to Step S16, where the processes from Step S16 to Step S24 are performed on the unprocessed halftone dot in the same manner as described above.

Then, when the conversion to the three-dimensional data containing depth data for all halftone dots is completed, this three-dimensional conversion process terminates.

It should be noted that the above description is just an example, and in reality, optimal values of the parameters and tables are required to be acquired by considering the difference in printing pressure depending on the characteristics of screen data (number of lines and angle of a halftone dot for AM) and the type of printing articles, further depending on the number of lines and angle of the anilox roller used in printing for flexographic printing.

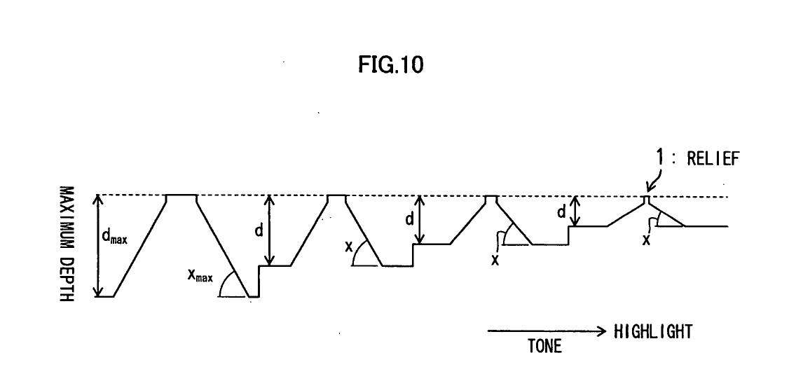

FIG. 10 illustrates an example of a longitudinal section of a flexographic printing plate (relief printing plate) which is laser engraved by the laser engraver based on the three-dimensional data containing depth data generated as described above.

As illustrated in FIG. 10, a relief 1 formed on a surface of the flexographic printing plate is formed such that the smaller the apex thereof (the one corresponding to the highlight halftone dot with larger tone), the gradually smaller from maximum depth dₘₐₓ (500 μm in the present embodiment) the depth d of the relief 1 becomes, and the gradually smaller from maximum tilt angle xₘₐₓ (60° in the present embodiment) the tilt angle x of the ridge line of the relief becomes.

Thereby, even the relief 1 of the highlight halftone dot has resistance to the pressure applied to the apex thereof thanks to the depth d and the tilt angle x of the ridge line of the frustoconical relief 1. Thus, even the highlight halftone dot such as a halftone dot (1% halftone dot) smaller than the cell 8A of the anilox roller 8 illustrated in FIG. 15 can be made not to fall over by the pressure applied to the apex thereof, and the relief 1 serving as a highlight halftone dot can be made not to be dipped in the cell 8A of the anilox roller 8.

### Second Embodiment of Three-Dimensional Conversion Method

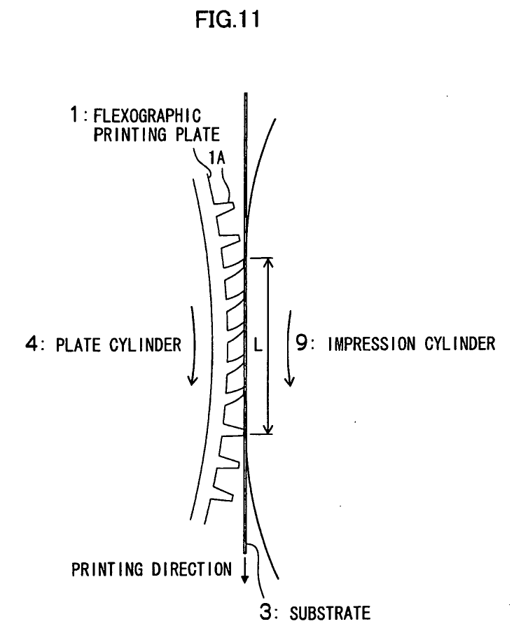

FIG. 11 is an enlarged view of the essential parts of a flexographic printer. As illustrated in FIG. 11, a substrate 3 is pinched and conveyed between a flexographic printing plate 1 mounted on a plate cylinder 4 and an impression cylinder 9 in a printing direction.

At this time, the flexographic printing plate 1 is slightly deformed by a pressure against the impression cylinder 9; a relief 1A and the substrate 3 move in contact with each other or spaced apart by a predetermined distance L (about 10 mm); and during this period, ink attached on an apex of the relief 1A is transferred to the substrate 3.

In the example of FIG. 11, the relief 1A is deformed by a pressure applied from the impression cylinder 9 via the substrate 3 so as to prevent slipping or sliding from occurring while the apex of the relief 1A is moving in contact with the substrate 3.

In contrast to this, if the relief 1A is not flexible in the printing direction, slight slipping or sliding occurs while the apex of the relief 1A is moving in contact with the substrate 3. As a result, a circular halftone dot becomes elliptical, causing dot gain.

In light of this, the following second embodiment of the three-dimensional conversion method is configured to generate three-dimensional data containing depth data to form a relief which has resistance to pressure as the entire relief and is flexible in the printing direction.

According to the second embodiment of the three-dimensional conversion method, the three-dimensional parameter calculating method in Step S16 and the basic shape data calculating method in Step S18 of the flowchart illustrated in FIG. 4 are changed as follows.

The three-dimensional parameters calculated in Step S16 determine basic shape data of an elliptic cone and include five parameters: a tilt angle x of the elliptic cone in a direction of the minor axis; a tilt angle y of the elliptic cone in a direction of the major axis; a cap height with a predetermined height above the apex of the elliptic cone; a maximum depth which is a sum of the elliptic cone height and the cap height; and a basic area.

That is, the second embodiment of the three-dimensional conversion method differs from the first embodiment of the three-dimensional conversion method in that in the first embodiment thereof, the three-dimensional parameters determine basic shape data of a cone, while in the second embodiment thereof, the three-dimensional parameters determine basic shape data of an elliptic cone.

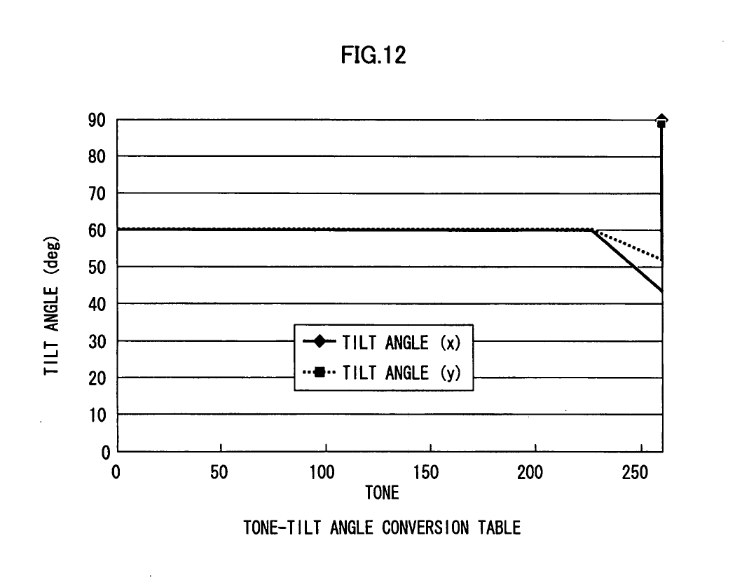

Of the parameters for determining the basic shape data of an elliptic cone, the tilt angle x of the elliptic cone in a direction of the minor axis and the tilt angle y of the elliptic cone in a direction of the major axis are obtained in such a manner that the value of multi-value image data corresponding to all ON pixels in the binary image data is used as the input value, and the tilt angles x and y corresponding to the input value are read from the tone-tilt angle conversion table illustrated in FIG. 12.

The tone-tilt angle conversion table illustrated in FIG. 12 is a table illustrating a relationship between the 256 tone values from 0 to 255 and the tilt angle x in the minor axis direction and the tilt angle y in the major axis direction of the relief corresponding to each tone value. In the example of FIG. 12, the tilt angles x and y corresponding to a tone value of about 220 or less are constant 60°, while in a highlight tone exceeding a tone value of about 220, the more tone value, the smaller the tilt angles x and y each with a different ratio.

It should be noted that the tilt angles x and y corresponding to a tone value of about 220 or less are constant 60°, and thus the tilt angles x and y are used as parameters for determining the basic shape data of a cone in the same manner as in the first embodiment.

Next, in Step S18, the basic shape data of a cone or an elliptic cone is calculated from the tilt angles x and y read from the tone-tilt angle conversion table of FIG. 12 based on the multi-value image data (tone) of a halftone dot and the preliminarily determined fixed data of the maximum depth and the cap height.

The method of calculating three-dimensional data containing depth data using basic shape data of an elliptic cone is the same as the method of calculating three-dimensional data containing depth data using basic shape data of a cone.

In this manner, the three-dimensional data containing depth data for engraving an elliptical frustoconical relief can be calculated by changing the basic shape data corresponding to a relief of a highlight halftone dot to that of an elliptic cone.

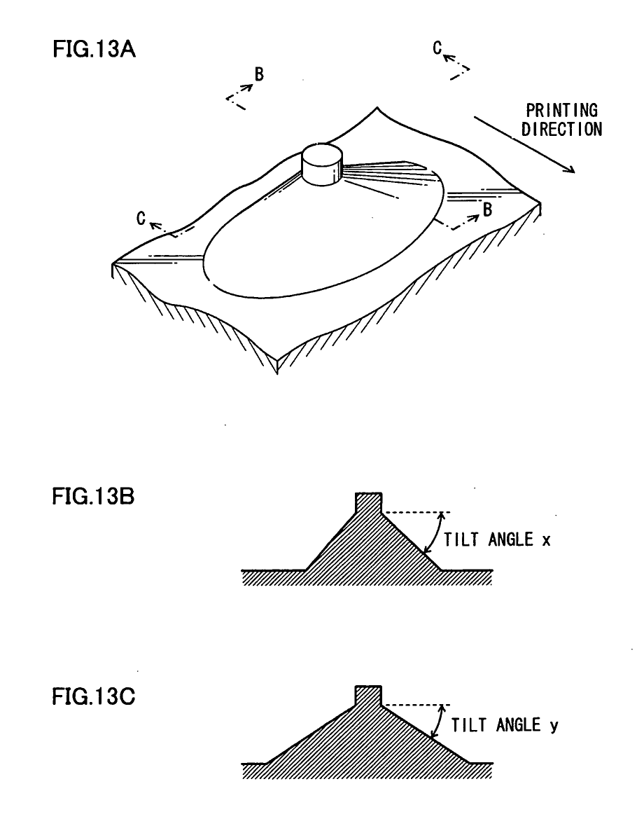

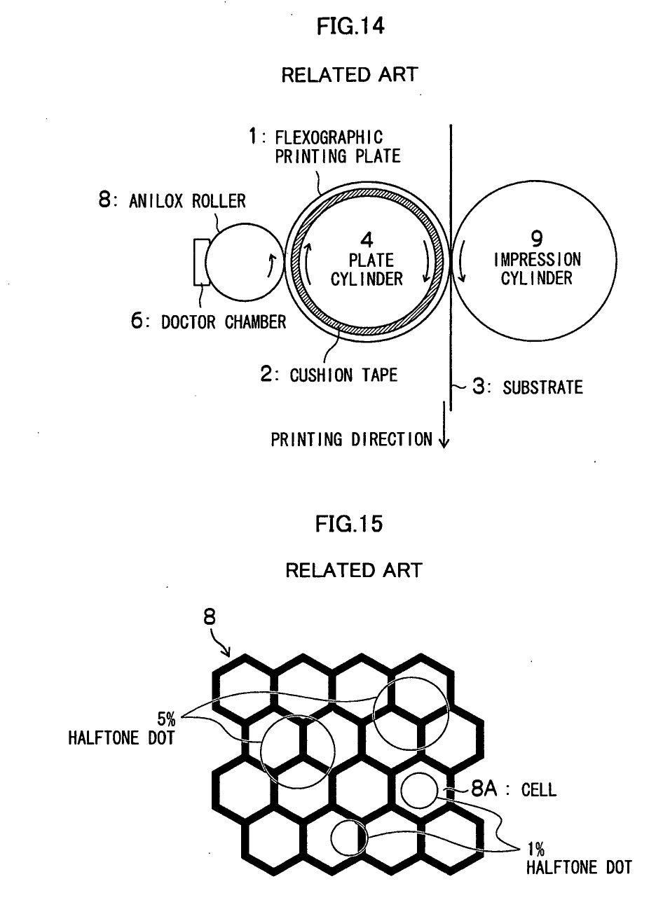

FIGS. 13A to 13C illustrate an elliptical frustoconical relief formed on a surface of the flexographic printing plate; FIG. 13A is a plan view illustrating the elliptical frustoconical relief; and FIGS. 13B and 13C each are a sectional view as viewed from the B-B line and the C-C line of FIG. 13A respectively.

As illustrated in FIG. 13A, an elliptical frustoconical relief is formed on the flexographic printing plate in such a manner that the minor axis direction thereof matches the printing direction and the major axis direction thereof is orthogonal to the printing direction. Thereby, the relief is formed in such a manner that the longitudinal section of the relief in the same direction as in the printing direction is smaller than the longitudinal section of the relief in the direction orthogonal to the printing direction (FIGS. 13B and 13C). As a result, the elliptical frustoconical relief is formed in such a manner that the flexibility in the same direction as in the printing direction is higher than that in the direction orthogonal to the printing direction.

That is, the resistance to pressure against the relief can be improved by reducing the depth of the relief on the highlight halftone dot and reducing the tilt angle of the ridge line thereof as well as the relief also has a flexibility in the printing direction by increasing the tilt angles of the ridge line in the printing direction more than the tilt angles of the ridge line in the direction orthogonal to the printing direction.

### Other Embodiments

The relationship between the tone of a halftone dot and the depth of a relief corresponding to the halftone dot is not limited to the one illustrated in the tone-depth conversion table of FIG. 7, but various modifications can be considered and may be any relationship as long as the more the tone, the smaller the depth in at least the highlight tone range.

Likewise, the relationship between the tone of a halftone dot and the tilt angle of a relief corresponding to the halftone dot is not limited to the one illustrated in the tone-tilt angle conversion table of FIGS. 8 and 12, but various modifications can be considered and may be any relationship as long as the more the tone, the smaller the tilt angle of the relief in at least the highlight tone range.

Moreover, the method of calculating the depth and the tilt angle of the relief is not limited to the method using a conversion table, but the depth and the tilt angle of the relief may be calculated based on a preliminarily calculated value or a relational expression indicating the relationship between tone and depth.

Further, in the present embodiment, a cap with a predetermined height is formed on the apex of a relief, but no cap may be provided on the apex of a relief. In this case, the parameter indicating the cap height is removed from the parameters of the basic shape data.

Note that in the present embodiment, the description has been made by taking an example of flexographic printing, but the present embodiment is effective for relief printing using a flexible plate material such as plastic.

Moreover, the substrate is not limited to paper, but the present embodiment is effective for films such as packages and base materials such as printed circuit boards and FPDs having micropattern printing.

Further, in the present embodiment, the description has been made by taking an example in which the apex of the relief is flat, but the apex of the relief is not limited to this shape and may be round. In the case where the apex of the relief is round, the amount of transferred ink is changed depending on the printing pressure. In general, the shape is formed by assuming some printing pressure (printing condition) and thus the portion to which ink is transferred under the assumed condition is called “the apex of the relief”.

Moreover, the present invention is not limited to the aforementioned embodiments, but it will be apparent that various modifications can be made to the present invention without departing from the spirit and scope of the present invention.

### DESCRIPTION OF SYMBOLS

1 Flexographic printing plate
3 Substrate
8 Anilox roller
10 RIP processing unit
12 Screening unit
14 Three-dimensional conversion unit
16 Laser engraver
18 De-screening unit

1. A relief printing plate comprising:
a plate material; and
a frustoconical relief which is formed on a surface of the plate material and serves as a halftone dot, and to an apex of which ink is transferred by an ink roller, wherein
the relief is formed in such a manner that each relief is different in depth and ridge tilt angle depending on screened binary image data and multi-value image data representing a tone of each halftone dot.

2. The relief printing plate according to claim 1, wherein, assuming that a value of the multi-value image data corresponding to all the ON pixels in binary image data is used as an input value, the tilt angle is acquired by reading a tilt angle corresponding to the input value from a table or a relational expression representing a relationship between a tone of the multi-value image data and depth data of a relief of a halftone dot.

3. The relief printing plate according to claim 1, wherein the screened binary image data represent an ON pixel within a halftone dot matrix representing a tone of a halftone dot or an OFF pixel within the halftone dot matrix.

4. The relief printing plate according to claim 1, wherein a top surface of the relief is substantially on the same plane irrespective of size of an apex of each relief.

5. The relief printing plate according to claim 1, wherein the relief is formed in such a manner that the smaller the size of the apex is, the smaller the depth of the relief becomes as well as the smaller the ridge tilt angle of the relief becomes.

6. The relief printing plate according to claim 1, wherein the relief is formed in such a manner that the depth and the ridge tilt angle of the relief are changed only if the size of the apex of the relief is a predetermined size or smaller.

7. The relief printing plate according to claim 1, wherein the relief has an elliptical frustoconical shape having a minor axis in a same direction as a printing direction.

8. The relief printing plate according to claim 1, wherein the relief is formed in such a manner that a cap having a constant cross-section and a predetermined height is formed on the apex of the relief.

9. A plate-making method for making the relief printing plate according to claim 1, the method comprising:
a step of acquiring screened binary image data and multi-value image data representing a tone of each halftone dot;
a step of calculating depth data, which is depth data corresponding to depth and ridge tilt angle of a relief of each halftone dot, for each exposure scanning position on a plate material by a laser engraver based on the binary image data and the multi-value image data; and
a step of performing laser engraving on the plate material by the laser engraver based on the depth data of each of the exposure scanning position.

10. The plate-making method for the relief printing plate according to claim 9, wherein the step of calculating depth data for each exposure scanning position includes:
a step of initializing depth data stored in a depth data memory area corresponding to the exposure scanning position based on the binary image data and the multi-value image data, the step of initializing to 0s the depth data of a memory area corresponding to an ON pixel within a halftone dot matrix representing a tone of a halftone dot based on the binary image data as well as initializing depth data of a memory area corresponding to an OFF pixel within the halftone dot matrix to depth data corresponding to multi-value image data of a halftone dot represented by the halftone dot matrix;
a step of acquiring conical basic shape data corresponding to a ridge tilt angle of a relief based on multi-value image data of each halftone dot; and
a step of moving an apex of the basic shape data once along an outer circumference of a circle of ON pixels constituting a halftone dot; and
a step of updating the depth data stored in the memory area by the initialized depth data and the basic shape data, whichever is smaller, at each pixel constituting the outer circumference during the moving.

11. The plate-making method for the relief printing plate according to claim 10, further comprising a first table or a first relational expression representing a relationship between a tone of multi-value image data and depth data of a relief of the halftone dot,
wherein the initialization step is to acquire depth data corresponding to the multi-value image data from the first table or the first relational expression based on multi-value image data of a halftone dot within a halftone dot matrix and to perform initialization using the acquired depth data.

12. The plate-making method for the relief printing plate according to claim 9, further comprising a second table or a second relational expression representing a relationship between a tone of multi-value image data and a tilt angle of a ridge of a relief of the halftone dot,
wherein the conical basic shape data includes parameters: a tilt angle of a ridge of a cone, a cap height with a predetermined height above the apex of the cone, and a maximum depth which is a sum of the cone height and the cap height; and
wherein the step of acquiring the basic shape data is to acquire a ridge tilt angle of a relief corresponding to the multi-value image data from the second table or the second relational expression based on the multi-value image data of each halftone dot and to calculate the basic shape data based on the acquired tilt angle, the cap height, and the maximum depth.

13. A plate-making apparatus for making the relief printing plate according to claim 1, comprising:
a data acquisition device which acquires screened binary image data and multi-value image data representing a tone of each halftone dot;
a three-dimensional conversion device which calculates depth data, which is depth data corresponding to depth and ridge tilt angle of a relief of each halftone dot, for each exposure scanning position on a plate material by a laser engraver based on the acquired binary image data and the multi-value image data; and
a laser engraver which performs laser engraving on the plate material based on the depth data for each exposure scanning position calculated by the three-dimensional conversion device.

14. The plate-making apparatus according to claim 13, wherein
when the input data is page data, the data acquisition device acquires multi-value image data by converting the page data to multi-value image data for each page and acquires binary image data by screening the multi-value image data under a preliminarily specified conditions, and
when the input data is screened binary image data, the data acquisition device acquires multi-value image data by de-screening the binary image data.
